(19) United States
(12) Patent Application Publication
(10) Pub. No.: US 2014/0280784 A1
(43) Pub. Date: Sep. 18, 2014

(54) File Transfer Based Upon Streaming Format

(71) Applicant: General Instrument Corporation, Horsham, PA (US)

(72) Inventors: Paul Moroney, La Jolla, CA (US); Mark S Schmidt, San Diego, CA (US); William J Willcox, Groton, MA (US)

(73) Assignee: General Instrument Corporation, Horsham, PA (US)

(21) Appl. No.: 14/214,592

(22) Filed: Mar. 14, 2014

Related U.S. Application Data
(60) Provisional application No. 61/801,368, filed on Mar. 15, 2013.

(51) Int. Cl. H04L 29/06

(52) U.S. Cl. CPC H04L 65/60
USPC 709/219

(57) ABSTRACT

Systems and methods are provided for delivery and playback of bounded multimedia data files. A media gateway communicates with a client device, the communications being related to content lists, playlists, media assets, and security dialogs. A client device can perform playback while in communication with a media gateway. Several playlist can be employed.

### CLAIM OF PRIORITY

This application claims priority under 35 U.S.C. §119(e) from earlier filed U.S. Provisional Application Ser. No. 61/801,368, filed Mar. 15, 2013, which is hereby incorporated by reference.

### TECHNICAL FIELD

The present disclosure relates to the field of data transmission techniques. Embodiments of the invention relate to techniques that allow transfer of bounded multimedia data files.

### BACKGROUND

Home networks can comprise media gateway devices, and client devices that are capable of playback of multimedia assets. A media gateway can comprise a media streamer, and the media streamer can have the capability of providing a bounded media asset, such as a television program sourced from a specified channel over a specified time span. A movie comprising audio and video data is a typical example of such a bounded media asset.

A user may wish to transfer such a bounded media asset from a media streamer to a client device, thus enabling playback of the media asset from the client device. Playback may be desired during a transfer and/or following a completed transfer. Playback may be desired while the client device and the media streamer are in electronic communication over a home network, and, while the client device is essentially not in electronic communication with the media streamer.

For some media assets, security functions must be addressed by a system. These can include user access rights, copy protection, and other related issues. Thus what are needed is systems for efficient and secure transfer of bounded media assets between components of a home network. There can be challenges to effective implementations for various use cases of such bounded media asset transfers. For example, a system optimized towards the streaming of unbounded streams of multimedia data between components may have relatively poor performance characteristics when transferring bounded media assets.

Some streaming implementations utilizing an HTTP Live Streaming (HLS) protocol can rely on a streaming media multimedia data asset being partitioned into a multitude of chunks of data, with a distinct file comprising each chunk. When applied to a bounded media asset, such an approach may result in undesirable inefficiencies such as file management overhead burden and/or excessive demands on network bandwidth. Thus there is a need for systems for media streamer tuning and recording with improved system characteristics.

### SUMMARY

According to embodiments of the present invention, a media streamer tuning and recording system is provided with improved characteristics over the prior art. The systems and methods disclosed provide for delivery and playback of bounded multimedia data files. In the systems, a media gateway communicates with a client device, the communications being related to content lists, playlists, media assets, and security dialogs. A client device can perform playback while in communication with a media gateway. Several playlist can be employed.

In one embodiment of the present invention, a system for delivery and playback of bounded multimedia data files is provided. The system includes a client device comprising local storage configured to: (1) perform playback responsive to at least one of a playlist file identifier, an asset file identifier, a security dialog, and local storage; (2) provide a playlist file request corresponding to a playlist file and the playlist file identifier, the playlist file comprising one or more instances of media URIs corresponding to an asset file; (3) provide an asset file request corresponding to an asset file and the asset file identifier, the asset file comprising a bounded media file; (4) instantiate the playlist file and the asset file in local storage; and, (5) selectively communicate with a media gateway, wherein the media URIs are referenced to the playlist file identifier.

### BRIEF DESCRIPTION OF THE DRAWINGS

Further details of the present invention are explained with the help of the attached drawings in which:

FIG. 1A depicts an exemplary embodiment of HLS file download flow.

FIG. 1B depicts an exemplary embodiment of a playlist.

FIG. 2 depicts an exemplary embodiment of client HLS file playback.

FIG. 3 depicts an exemplary embodiment of HLS file progressive download with concurrent playback.

FIG. 4 depicts an exemplary embodiment of a playlist.

FIG. 5 depicts an exemplary embodiment of a playlist.

FIG. 6 depicts an exemplary embodiment of a playlist.

FIG. 7 depicts an exemplary embodiment of a manifest.

FIG. 8 depicts an exemplary embodiment of a playlist.

FIG. 9 depicts an exemplary embodiment of a computer system.

### DETAILED DESCRIPTION

### HTTP Live Streaming

HTTP Live Streaming, identified herein as HLS, is an HTTP-based communications protocol suitable for media streaming, described in Internet Drafts to the Internet Engineering Task Force such as HTTP Live Streaming draft-pantos-http-live-streaming-10, Oct. 15, 2012. Using this file-based protocol that is generally not a streaming protocol, a server can send one or more media streams, and a client can receive one or more of the media streams.

Systems for delivery and playback of media streams can employ HLS. In various embodiments, HLS server and HLS client functionality can reside in various devices within such systems. Some devices can be networked devices. Many applications of an HLS protocol support streaming of unbounded streams of multimedia data. With HLS, HTTP can provide support for streaming, although HTTP is generally not a streaming protocol. HLS features can be employed as described herein to support transfer of media assets that are bounded multimedia data files, such as recorded programs of specified and finite duration.

System characteristics, such as performance and/or behaviors, can be influenced by specific design choices in the implementation of HLS. In some embodiments, such a system characteristic can be latency between selection of a media asset and the display of that media asset to a user. In some embodiments, such choices can comprise specific methods and techniques of operation of and between system devices.

Design choices in the implementation of HLS can take into account known, measured, and/or observed characteristics of system elements. For example, a player element may have some known, but essentially not adjustable, characteristics.

### Diagram 1001 Depicts an Exemplary Embodiment of HLS File Download Flow.

A Media Streamer 1301 can comprise Recorded Content storage 1331, Digital Rights Management Server 1333, Content Directory Service 1335, and Content/HLS Server 1337. In some embodiments, a Media Gateway can comprise the Media Streamer 1301.

Recorded Content storage 1331 can provide storage for recorded content, as depicted by example file names movie.ts, Football_game.ts, and TVshow.ts. These filenames with suffix “.ts” indicate that the files are media segment files according to HLS protocol.

Content Directory Service 1335 can maintain and/or provide a list of content corresponding to the recorded content at Recorded Content storage 1331. Such a list can comprise names of playlist files, as depicted by example file names Movie.m3u8, Football_game.m3u8, and TVshow.m3u8. These filenames with suffix “.m3u8” indicate that the files are playlist files according to HLS protocol.

A Client 1101 can comprise Client Player Application 1111, SDCard Recorded Content storage 1131, and AVPlayer 1121. The Client Player Application 1111 can comprise DRM rights acquisition and HTTPS key server 1113, HLS Content HTTP Proxy Server 1115, and Content download management 1117. In some embodiments, a Media Player device can comprise Client 1101.

SDCard Recorded Content storage 1131 can store recorded content, as depicted by example file names Movie.m3u8 and movie.ts. That is, this storage can comprise media segment files and playlist files corresponding to a specific media asset. In some embodiments, a device comprising a Secure Digital memory device such as a SD memory card, can comprise SDCard Recorded Content storage 1131.

Diagram 1001 depicts an example embodiment of a download of an example HLS movie file movie.ts and manifest Movie.m3u8 1201 to Client 1101. In some embodiments, the media asset comprising movie.ts and Movie.m3u8 can be played back at a later time, such as a time when Client 1101 is not in electronic communication with Media Streamer 1301.

The term manifest is used herein to describe a playlist file that contains information about files that are additional to the manifest file, that are associated with a specific media asset. This meaning can be in addition to the understanding, as well known in the related arts, that a manifest file contains information about accompanying files in the same archive.

The term “Sync N Go” is used herein in association with specific use case embodiments. In such embodiments, a Media Streamer 1301 can at some times be in electronic communication with a Client such as 1101. By way of non-limiting example, such electronic communication can take place over a home or other network. During such times, media assets can be transferred from Media Streamer to Client, and instantiated within storage local to the Client, such as 1131 SDCard. At other times, Media Streamer and Client can essentially be out of electronic communication. By way of non-limiting example, such a time can occur when a device comprising Client is not connected with the Media Streamer via network or other means. There are a variety of causes available for such lack of connection. In some embodiments, such a Client can perform playback of a media asset from local storage, while the client is not concurrently in electronic communication with the Media Streamer that provided the media asset.

In process step 1401, depicted as “1) GET content list,” Client Player Application 1111 invokes HTTP request method GET to Content Directory Service 1335, thereby implementing a content list request.

In process step 1402, depicted as “2) Return content list,” Content Directory Service 1335 returns the requested content list to Client Player Application 1111. Such a content list can comprise identifiers, such as uniform resource identifiers, URIs, corresponding to specific playlist files and specific asset files. In the depicted example embodiment, the content list can comprise an asset file identifier corresponding to asset file movie.ts, and/or, a playlist file identifier corresponding to playlist file Movie.m3u8.

In process step 1403, depicted as “3) GET content rights and keys for movie.ts,” DRM rights acquisition and HTTPS key server 1113 can dialog with Digital Rights Management server 1333, in order to establish content rights and/or keys for a specific file, such as movie.ts. Such a security dialog can comprise the depicted GET. In some embodiments, such a security dialog can provide such content keys and/or rights to Client system component 1113 “DRM rights acq. and HTTPS key server.” In some embodiments, a component of a Client 1101 that participates in such a security dialog can be described as performing a security dialog. In some embodiments, a component of a Media Streamer 1301 that participates in such a security dialog can be described as performing a security dialog.

In process step 1404, depicted as “4) GET Movie.m3u8,” Content download management 1117 issues a playlist file request for a specific playlist file, Movie.m3u8, to Content/HLS Server 1337. A playlist file embodiment Movie.m3u8 1201 is depicted in diagram 1001. Additional detail of an example embodiment of such a file is depicted and described herein as playlist 1701 in diagram 1501.

In process step 1405, depicted as “5) HTTP 200 OK Movie.m3u8,” Content/HLS Server 1337 fulfills the request, providing the specified playlist file Movie.m3u8 and/or a corresponding playlist file identifier, and indicates to Content download management 1117 that the request for Movie.m3u8 is fulfilled.

In process step 1406, depicted as “6) GET movie.ts,” Content download management 1117 can issue an asset file request for a specific asset file, movie.ts, to Content/HLS Server 1337.

In process step 1407, depicted as “step 7) HTTP 200 OK movie.ts,” Content/HLS Server 1337 can fulfill the asset file request, providing the specified asset file movie.ts and/or a corresponding asset file identifier, and can indicate to Content download management 1117 that the request for movie.ts is fulfilled.

In process step 1408, depicted as “8) Store Movie.m3u8 and movie.ts on SDCard,” Content download management 1117 and storage 1131 instantiate specified playlist and asset files, respectively Movie.m3u8 and movie.ts, in SDCard Recorded Content 1131 local storage.

### Diagram 1501 Depicts an Exemplary Embodiment of a Playlist File 1701.

This playlist 1701 corresponds to some operations corresponding to an HLS protocol.

Line 1601 indicates that this playlist file is an extended m3u file. According to some HLS specifications, this can be a necessary condition for HLS operations.

Line 1602 specifies a maximum media segment duration of 2 seconds.

Line 1603 specifies the sequence number of the first segment as 0.

Line 1604 specifies a decryption method and key URI for specified media segments.

Line 1605 specifies the duration of the following media segment to be 2 seconds.

Line 1606 specifies that a media segment is a sub-range of the resource identified by the next media URI that follows it in the playlist. The sub-range length is specified as 154543 bytes, with an offset of 0 bytes.

Line 1607 identifies “movie.ts” media URI, as the next media URI to Line 1606. Thus the sub-range of Line 1606 is within the movie.ts resource.

Line 1608 specifies the duration of the following media segment to be 2 seconds.

Line 1609 specifies that a media segment is a sub-range of the resource identified by the next media URI that follows it in the playlist. The sub-range length is specified as 135778 bytes. The sub-range begins at the next byte following the sub-range of the previous media segment.

Notably, the sub-range length of this media segment, in bytes, differs from the sub-range length of the previous segment, although both have specified durations of 2 seconds.

Line 1610 identifies “movie.ts” media URI.

Line 1611 indicates that some embodiments can comprise additional media segment descriptions repeating functions similar to Lines 1608, 1609, 1610.

Lines 1612, 1613, 1614 respectively repeat the functions of Lines 1608, 1609, 1610.

Line 1615 indicates that no more media segments will be added to the playlist file. In some embodiments, this can be indicative of a bounded media asset. That is, in some embodiments there can a single playlist, such as playlist 1701, that describes and/or otherwise corresponds to the entire contents of a corresponding asset file, such as movie.ts, as depicted in diagram 1501.

Embodiments corresponding to diagram 4001 have been described with reference to specific elements thereof. It will, however, be evident that various modifications and changes may be made thereto without departing from the broader spirit and scope of the embodiments. Thus the drawings and descriptions are, accordingly, to be regarded in an illustrative rather than restrictive sense.

### Diagram 2001 Depicts an Exemplary Embodiment of Client HLS File Playback.

A Client 2101 can comprise Client Player Application 2111, SDCard Recorded Content storage 2131, and AVPlayer 2121. The Client Player Application 2111 can comprise DRM rights acquisition and HTTPS key server 2113, HLS Content HTTP Proxy Server 2115, and Content download management 2117. In some embodiments, a Media Player device can comprise Client 2101.

SDCard Recorded Content storage 2131 can store recorded content, as depicted by example file names Movie.m3u8 and movie.ts. That is, this storage can comprise media segment files and playlist files corresponding to a specific media asset. In some embodiments, a device comprising a Secure Digital memory device such as a SD memory card, can comprise SDCard Recorded Content storage 2131.

Diagram 2001 depicts a flow diagram for the playback of an HLS movie asset comprising Movie.m3u8 and movie.ts files from Client 2101 storage 2131. In some embodiments, a device comprising Client 2101 can be remote and/or not in electronic communication with a Media Streamer, such as Media Streamer 2301.

In process step 2401, depicted “1) Play http://localhost/Movie.m3u8,” Client Player Application 2111 can direct AVPlayer 2121 to initiate playback of a specified media asset corresponding to a specified playlist file, Movie.m3u8. In some embodiments, such playback can comprise process steps 2402 2403 and 2404.

In process step 2402, depicted as “2) GET http://localhost/Movie.m3u8,” AVPlayer 2121 can issue a playlist file request for a specified playlist, Movie.m3u8, to HLS Content HTTP Proxy Server 2115. HLS Content HTTP Proxy Server 2115 and SDCard Recorded Content 2131 can respond in combination to fulfill the request. Such fulfillment can comprise providing the specified playlist file Movie.m3u8 and/or a corresponding playlist file identifier. A playlist file embodiment Movie.m3u8 2201 is depicted in diagram 2001. Additional detail of an example embodiment of such a file is depicted and described herein as playlist 1701 in diagram 1501.

In process step 2403, depicted as “3) GET keys (Secure key transfer),” AVPlayer 2121 can dialog with DRM rights acquisition and HTTPS key server 2113, in order to establish content rights and/or keys for a specific file, such as movie.ts. Such a security dialog can comprise the depicted GET. In some embodiments, such a security dialog can provide such content keys and/or rights to Client system component AVPlayer 2121. In some embodiments, a component of a Client 2101 that participates in such a security dialog can be described as performing a security dialog. In some embodiments, such a security dialog can be performed and/or completed substantially and/or completely within a Client 2101.

In process step 2404, depicted as “4) GET http://localhost/movie.ts byterange chunks,” AVPlayer 2121 can issue an asset file request for specified file movie.ts to HLS Content HTTP Proxy Server 2115. HLS Content HTTP Proxy Server 2115 and SDCard Recorded Content 2131 can respond in combination to fulfill the request. Such fulfillment can comprise providing the specified asset file, movie.ts, and/or a corresponding asset file identifier. Notably, in some embodiments, fulfillment of the request can comprise techniques employing byterange chunks. The term “chunk” as used herein can correspond to a specific sub-range of a data set. In some embodiments, a chunk can correspond to a media segment.

Diagram 3001 Depicts an Exemplary Embodiment of HLS File Progressive Download with Concurrent Playback.

A Media Streamer 3301 can comprise Recorded Content storage 3331, Digital Rights Management Server 3333, Content Directory Service 3335, and Content/HLS Server 3337. In some embodiments, a Media Gateway can comprise the Media Streamer 3301.

Recorded Content storage 3331 can provide storage for recorded content, as depicted by example file names movie.ts, Football_game.ts, and TVshow.ts. These filenames with suffix “.ts” indicate that the files are media segment files according to HLS protocol.

Content Directory Service 3335 can maintain and/or provide a list of content corresponding to the recorded content at Recorded Content storage 3331. Such a list can comprise names of playlist files, as depicted by example file names Movie.m3u8, Football_game.m3u8, and TVshow.m3u8. These filenames with suffix “.m3u8” indicate that the files are playlist files according to HLS protocol.

A Client 3101 can comprise Client Player Application 3111, SDCard Recorded Content storage 3131, and AVPlayer 3121. The Client Player Application 3111 can comprise DRM rights acquisition and HTTPS key server 3113, HLS Content HTTP Proxy Server 3115, and Content download management 3117. In some embodiments, a Media Player device can comprise Client 3101.

SDCard Recorded Content storage 3131 can store recorded content, as depicted by example file names Movie.m3u8 and movie.ts. That is, this storage can comprise media segment files and playlist files corresponding to a specific media asset. In some embodiments, a device comprising a Secure Digital memory device such as a SD memory card, can comprise SDCard Recorded Content storage 3131.

In process step 3401, depicted as “1) GET content list,” Client Player Application 3111 invokes HTTP request method GET to Content Directory Service 3335, thereby implementing a content list request.

In process step 3402, depicted as “2) Return content list,” Content Directory Service 3335 returns the requested content list to Client Player Application 3111. Such a content list can comprise identifiers, such as uniform resource identifiers, URIs, corresponding to specific playlist files and specific asset files. In the depicted example embodiment, the content list can comprise an asset file identifier corresponding to asset file movie.ts, and/or, a playlist file identifier corresponding to playlist file Movie.m3u8.

In process step 3403, depicted as “3) GET content rights and keys for movie.ts,” DRM rights acquisition and HTTPS key server 3113 can dialog with Digital Rights Management server 3333, in order to establish content rights and/or keys for a specific file, such as movie.ts. Such a security dialog can comprise the depicted GET. In some embodiments, such a security dialog can provide such content keys and/or rights to Client 3101 system component 3113 “DRM rights acq. and HTTPS key server.” In some embodiments, a component of a Client 3101 that participates in such a security dialog can be described as performing a security dialog. In some embodiments, a component of a Media Streamer 3301 that participates in such a security dialog can be described as performing a security dialog.

In process step 3404, depicted as “4) GET Movie.m3u8,” Content download management 3117 issues a playlist file request for a specific playlist file, Movie.m3u8, to Content/HLS Server 3337. A playlist file embodiment Movie.m3u8 3201 is depicted in diagram 3001. Additional detail of an example embodiment of such a file is depicted and described herein as playlist 1701 in diagram 1501.

In process step 3405, depicted as “5) HTTP 200 OK Movie.m3u8,” Content/HLS Server 3337 fulfills the request, providing the specified playlist file Movie.m3u8 and/or a corresponding playlist file identifier, and indicates to Content download management 3117 that the request for Movie.m3u8 is fulfilled.

In process step 3406, depicted as “6) GET movie.ts byterange chunks,” Content download management 3117 can issue an asset file request for a specific asset file, movie.ts, to Content/HLS Server 3337.

In process step 3407, depicted as “step 7) HTTP 200 OK movie.ts byteranges,” Content/HLS Server 3337 can fulfill the asset file request, providing the specified asset file movie.ts and/or a corresponding asset file identifier, and can indicate to Content download management 3117 that the request for movie.ts is fulfilled.

In process step 3408, depicted as “8) Store Movie.m3u8 and movie.ts on SDCard,” Content download management 3117 and local storage 3131 instantiate specified playlist and asset files, respectively Movie.m3u8 and movie.ts, in SDCard Recorded Content 3131 local storage.

In process step 3409, depicted “9) Play http://localhost/Movie.m3u8,” Client Player Application 3111 can direct AVPlayer 3121 to initiate playback of a specified media asset corresponding to a specified playlist file, Movie.m3u8. In some embodiments, such playback can comprise process steps 3410 3411 and 3412.

In process step 3410, depicted as “10) GET http://localhost/Movie.m3u8,” AVPlayer 3121 can issue a playlist file request for a specified playlist, Movie.m3u8, to HLS Content HTTP Proxy Server 3115. HLS Content HTTP Proxy Server 3115 and SDCard Recorded Content 3131 can respond in combination to fulfill the request. Such fulfillment can comprise providing the specified playlist file Movie.m3u8 and/or a corresponding playlist file identifier. A playlist file embodiment Movie.m3u8 3201 is depicted in diagram 3001. Additional detail of an example embodiment of such a file is depicted and described herein as playlist 1701 in diagram 1501.

In process step 3411, depicted as “3) GET keys (Secure key transfer),” AVPlayer 3121 can dialog with DRM rights acquisition and HTTPS key server 3113, in order to establish content rights and/or keys for a specific file, such as movie.ts. Such a security dialog can comprise the depicted GET. In some embodiments, such a security dialog can provide such content keys and/or rights to Client system component AVPlayer 3121. In some embodiments, a component of a Client 3101 that participates in such a security dialog can be described as performing a security dialog. In some embodiments, a component of a Media Streamer 3301 that participates in such a security dialog can be described as performing a security dialog. In some embodiments, such a security dialog can be performed and/or completed substantially and/or completely within a Client 3101.

In process step 3412, depicted as “12) GET http://localhost/movie.ts byterange chunks,” AVPlayer 3121 can issue an asset file request for specified file movie.ts to HLS Content HTTP Proxy Server 3115. HLS Content HTTP Proxy Server 3115 and SDCard Recorded Content 3131 can respond in combination to fulfill the request. Such fulfillment can comprise providing the specified asset file, movie.ts, and/or a corresponding asset file identifier. Notably, in some embodiments, fulfillment of the request can comprise techniques employing byterange chunks.

In an embodiment, during download of a specified asset file, movie.ts, from content server Media Streamer 3301 in steps 6 and 7, the Client Player Application 3111 can concurrently initiate playback. Such playback can comprise decoding and rendering operations for byterange chunks of the asset file, movie.ts, subsequent to transfer of the chunks to Client 3101 local storage 3131. That is, process steps 3409-3413 can comprise playback, and such playback can begin prior to the completion of process steps 3406-3407.

### Fast Tuning:

In some embodiments Client 1101 2101 3101 can comprise a player, such as an iOS media player application. Some observed and/or otherwise known characteristics of the player and/or the system can be described.

A characteristic of some embodiments can be that the iOS media player will receive and buffer at least two seconds of video before playback begins. A characteristic of some embodiments in which network bandwidth is not at issue, and employing chunks of one or two-second durations, can be that playback will not begin earlier than the time at which the player “sees” the playlist for a subsequent chunk “advertised.” That is, playback can begin at or after the time at which the playlist for the subsequent check is available to the player from a server.

Network bandwidth is not at issue for some embodiments comprising a reasonably fast WiFi network. A WiFi network can be characterized as a reasonably fast WiFi network for a particular video and/or other stream, herein, if the network delivers at least three times (3×) the real time content rate of that video and/or other stream.

A characteristic of some embodiments employing one-second chunk durations can be that the player can transfer each of a first two chunks upon those two chunks being advertised, and can begin playback when the player obtains a playlist that includes a third chunk.

In some embodiments there can be 4 frames of 33 millisecond video frames pipelined for an encode process at the Media Streamer 1301 3301, and two frames of latency inside a client player. Such an embodiment can have a characteristic of a delay of at least 3.2 seconds between the time at which an asset is encoded and the time of display of that asset to a user of the player.

In some embodiments, such a 3.2 second delay can comprise the causes as described immediately above: three one-second chunks, four 33 msec frames attributed to an encode process, and two 33 msec frames of latency attributed to a client player.

Under the conditions of the 3.2 second delay, and a reasonably fast WiFi network, some player embodiments, such as an internal iOS player, can comprise a content buffer that will ramp up to two seconds of stored video, then later start playback. Such a buffer can shrink in real time, and can grow in bursts of receive chunk data. The buffer can represent a safety margin against channel performance fluctuations and conflicts in channel usage, so that a user experience can be of a smooth non-glitchy playback. For some embodiments comprising a reasonably fast WiFi network, the buffer size can vary between 2.7 and 2 seconds over time.

Some player embodiments can provide an illusion of a faster channel change, to a user of the player. In such an embodiment a player can grab a first decodable frame of a chunk, and display just that frame, while waiting for the buffer to fill. Thus, a user can experience a relatively rapid viewing of the first frame of a newly tuned channel, but the change is to a still frame that remains in view until the same time that non-trivial contents of a selected video stream would have been available by other methods.

In some embodiments, black frames can be employed to speed acquisition. Upon a server's production of a first non-trivial chunk of video, the server can advertise a pre-chunk of additional black frames. This can have the effect of reducing the delay until the start of playback by 1 second. However, the video played back starts with 1 full second of black frames. Thus the user/view can experience a more rapid change from a previously tuned channel, but the change is to black frames that remain in view until the same time that non-trivial contents of a selected video stream would have been available by other methods. The buffer size can be unaffected.

In some embodiments, half second chunks can be employed. In such embodiments, acquisition times can be improved by one half second, at the expense of about a half second smaller buffer. That is, a smaller buffer reduces the safety margin against channel performance fluctuations and conflicts in channel usage. In some embodiments this can be an acceptable trade-off. In some embodiments comprising Time Shift Buffer operations and/or full recordings, half second chunks can contribute to relatively large playlists, compared to the use of larger chunks. Relative to larger chunks, half second chunks can have poorer compression performance due to an increased number of I frames, as a typical embodiment comprises an I frame corresponding to each chunk.

In some embodiments, a server can present a playlist describing a chunk that is not yet complete, in order to stimulate playback at the player at an earlier time than would otherwise result. By way of non-limiting example, for the one-second chunks described above, the server can present a third chunk's availability in a playlist that is generated ½ second before the chunk is ready. In some embodiments an early start of playback does not result, as one full second passes prior to the client issuing a request. In some embodiments this request interval can be avoided by describing the third chunk in the same playlist in which the second chunk is first described. Thus, in some embodiments, a client can request the third chunk as soon as immediately after downloading the second chunk. In some embodiments, the server can hold off its reply until the referenced chunk contents are available, and/or trickle the chunk contents as they are generated. In some embodiments, such an approach can provide an improvement of reduced acquisition time at the expense of somewhat smaller buffer fullness, on average. That is, reduced buffer fullness correspondingly reduces a safety margin against channel performance fluctuations and conflicts in channel usage

In some embodiments comprising a very slow WiFi network, acquisition slows. A WiFi network can be herein characterized as a very slow WiFi network if the network bandwidth is less than 3 times the real time content rate, also described herein as a 3× network rate. Such a ratio of network bandwidth to real time content rate can be represented herein as a N× network rate, where N is the ratio.

Slowed acquisition is known and/or observed for some embodiments comprising elements, such as a player element, comprising an iOS 5.1 operating system and/or an earlier version of iOS. In some embodiments, instead of a client starting playback when a third one-second chunk is available, the client waits to complete transfer of that third chunk before initiating playback. By way of non-limiting example, for a 2x network rate, start of playback can increase from 3.2 seconds to 3.7 seconds.

### Time Shift Buffer:

Some embodiments of time shift buffer, TSB, can be described as a sliding window view of a portion of a bounded media asset. In other embodiments, a snapshot of the contents of a TSB can be at least temporarily described as a bounded media asset. In some embodiments, TSB operations can provide notable advantages in the media asset transfers herein described.

In some embodiments, a TSB can be described as a live tuned channel whose asset size grows with time. In some embodiments, a playlist grows from one chunk to N chunks, where N represents the maximum size of the TSB. One new chunk can be added to the end of the playlist as each old chunk is dropped, resulting in a constant size for the TSB. In an embodiment, a 30 minute TSB could have up to 1800 one-second chunks; a corresponding playlist size can be approximately 80 kilobytes in the steady state; diagram 4001 and corresponding description can apply to some such embodiments. In some embodiments, the playlist size can be reduced through employing naming conventions for each listed chunk, and/or a smart server. In some such embodiments, the playlist size can remain at approximately 40 kilobytes; diagrams 5001 6001 and descriptions can apply to some such embodiments. For embodiments comprising content at 1 megabit/second, content chunks can average 125K bytes. Thus the playlist size can, in some examples, be from 33%-66% as large as the content.

In some embodiments, a playlist size that is a substantial fraction of the size of the associated content can result in decreased performance, relative to smaller playlist sizes. Such decreased performance can comprise increased network demand and/or degraded playback, such as erratic playback.

In some embodiments, chunk sizes of 2 and/or 3 seconds can be employed in support of TSB operations. Two-second chunks can add one full second to the acquisition time delay, relative to one-second chunks. A three-second chunk size can similarly add further to such delay. In some embodiments, techniques to reduce delay, such as early advertising as described herein, can be employed.

In some embodiments, two-second chunks can be preferably employed. In example embodiments, content chunk size can average 250K bytes, and a 30 minute TSB playlist size can be approximately 20K bytes in size, corresponding to less than a 10% network overhead.

In an embodiment, when a first two-second content chunk is available, it can be advertised in a playlist that also lists a second chunk which is not yet available. In some embodiments comprising a reasonably fast WiFi network, a client can download the first chunk and can then begin playback. This can result in a 2.2 second start up time, comprising an improvement over a baseline one-second chunk example embodiment.

In some example embodiments comprising two-second chunks and a very slow network, such as a 2x network, acquisition delay can increase to 4.2 seconds. Such an increase can be avoided by providing sufficient network resources for the optimization described herein comprising chunk sizes of 2 seconds.

### Recorded Files

In some embodiments, media assets can be recorded to storage. Such media assets can be described as recorded files. Chunk sizes of 2 seconds and/or 3 seconds can be advantageously employed to reduce the size of a single playlist corresponding to such an embodiment. A completed recording can have an associated playlist file that comprises an ENDLIST tag; the ENDLIST tag indicates the single playlist file for the asset. When streaming such an asset for playback, a player can GET the single playlist, then download chunks as described herein to begin playback. The player can additionally continue to obtain chunks until an internal buffer is filled. In some embodiments, such a buffer can correspond to approximately 60 seconds of the asset.

Some such assets can be copied and/or downloaded across a network that can be a home network, such as between a Media Streamer 1301 and a client device 1101. An asset can be listed as a single file, such as “movie.ts” rather than as a collection of smaller files. For such a case, chunks can be described in a byte range offset style in the playlist. Thus each stored asset can be referred to by its single corresponding playlist .m3u8 file; with the playlist file including an ENDLIST tag. Clients can download and store one additional asset .ts file. Such an approach, comprising a standard HLS byte range offset style playlist format, can be advantageously employed in various embodiments. Such an approach can be advantageously employed in support of DLNA technologies.

Such media files can be played back by a client device employing a local host proxy. In such embodiments, the playlist can describe chunks using relative URIs. A playlist comprising relative URIs can be advantageously smaller in size than an essentially equivalent playlist comprising fully qualified URIs. An example of such a playlist corresponding to an asset of 5 minutes duration is depicted and described as diagram 8001.

### Playlist Compression

In some embodiments, playlist files can be compressed, thereby reducing the file size. HLS http GETs, such as process step 1404, depicted as “GET Movie.m3u8,” support the transfer of compressed playlist files. Media Streamer 1301 can comprise support for compression of, and/or management of compressed, playlist files. In some embodiments, this can sufficiently reduce the issue of relatively large TSB playlists, thereby enabling the use of chunks of 1 second size without undesirable effects on network bandwidth. In some embodiments, compression techniques can comprise “zip” processing.

### Chunk Encryption

In some embodiments, Media Streamer 1301 3301 comprises block encryption of chunks. In some such embodiments, a chunk must be complete prior to encryption. Thus there can be an effective delay in waiting for a chunk to complete, prior to encryption and subsequent operations. This can limit the applicability of some of the channel change techniques listed above. By way of example and not limitation, in the example herein comprising two-second chunks and a relatively fast network, a capability to trickle out chunk content can enable a player's buffer fullness to ramp to 2 seconds, and to then remain at that size/state/level, more or less indefinitely. However, block encryption can greatly increase the variability of the buffer size.

### Progressive Download

Diagram 3001 depicts a scenario of a Sync N Go file download to a client 3101 from a Media Streamer 3301. A client 3101 can comprise a player. In such a scenario, the player can concurrently play back an asset to a user, while the same asset is being downloaded from Media Streamer 3301. This scenario can be described as a progressive download.

When an asset is transferred as in a progressive download, the transfers of the corresponding media segment .ts file and playlist file .m3u8 can be decoupled from a security dialog that establishes content keys and rights. Thus a client 3101 can transfer a playlist file, identify a media segment file from it, transfer the media segment file, and then call a client security SDK in order to establish keys and rights for the corresponding content.

In some embodiments, the playlist file can be transferred first, then rights and keys established second, then the media segment file transfer initiated. This order of operations can be advantageous, in that it can allow a player to begin playback earlier than the completion of transfer of the media segment file. In some example embodiments, the completion of a transfer of a media segment file can require a substantial amount of time, such as many minutes. In such an embodiment, playback can begin substantially earlier than the completion of the transfer of the media segment file, thereby avoiding a substantial delay awaiting completion.

### Diagram 4001 Depicts an Exemplary Embodiment of a Playlist 4201.

Playlist 4201 corresponds to an example embodiment comprising an 1800 second asset file, and the use of BYTERANGE statements to specify a number of bytes for each 1 second segment.

Line 4101 indicates that this is an extended m3u file.

Line 4102 specifies a maximum media segment duration of 1 second.

Line 4103 specifies the sequence number of the first segment as 0.

Line 4104 specifies a decryption method for specified media segments.

Line 4105 specifies the duration of the following media segment to be 1 second.

Line 4106 specifies that a media segment is a sub-range of the resource identified by the next media URI that follows it in the playlist. The sub-range length is specified as 154543 bytes, with an offset of 0 bytes.

Line 4107 identifies “a.ts” relative media URI. That is, the media URI “a.ts” can be referenced relative to the URI of the playlist 4201 containing this URI.

Line 4108 specifies the duration of the following media segment to be 1 second.

Line 4109 specifies that a media segment is a sub-range of the resource identified by the next media URI that follows it in the playlist. The sub-range length is specified as 154543 bytes. The sub-range begins at the next byte following the sub-range of the previous media segment.

Line 4110 identifies “a.ts” relative media URI.

Lines 4111, 4112, 4113 respectively repeat the functions of Lines 4108, 4109, 4110.

Line 4114 repeats the functions of Lines 4111,4112, 4113 another 1795 times.

Lines 4115, 4116, 4117 respectively repeat the functions of Lines 4111,4112, 4113.

Lines 4118, 4119, 4120 respectively repeat the functions of Lines 4115, 4116, 4117.

In this example, a HLS #EXT-X-BYTERANGE tag is used to specify the size of a one-second media segment in bytes. The #EXTINF tag signals one-second segment time durations. A client player can maintain a running accumulation of the segment sizes, corresponding to BYTERANGE values, to determine an individual file offset in bytes at which to request a given segment. This playlist can represent the first 1800 segments of a TSB. As time progresses beyond 1800 seconds, the #EXT-X-MEDIA-SEQUENCE number can increment each second while the first media segment is deleted from such a sliding-window playlist, and the latest media segment is added to the end of the playlist. Byte range sizes are depicted showing a default value; in some embodiments chunks can vary in size from this default value. The file name “a.ts” minimizes the number of characters used for the file name. A longer, and possibly more informative, name could add materially to the overall file length. An asset file can comprise a plurality of chunks, and notably such an asset file can be identified as a resource throughout a playlist, such as playlist 4201, by a single asset name, such as a.ts.

The playlist file 4201 depicted has a size of 77556 bytes.

In this live playlist using BYTERANGE, the first byte range tag contain the offset in bytes into the media segment file, a.ts, at which the range of bytes can be referenced. A player can calculate other offsets by accumulating the chunk sizes. As the playlist changes, the EXT-X-MEDIA-SEQUENCE number increments, and the first advertised byte range tag changes to identify the @offset value for the new first byte range segment into the media file.

In some embodiments, an additional client that can comprise an additional player can also begin to play this same asset while the live TSB playlist has a number of byte range media chunks listed in it. In such an embodiment, the additional client can download the last 3 byte range segments given at the end of the playlist 4201, and can begin playback from the position indicated by those byte range segments.

Embodiments corresponding to diagram 4001 have been described with reference to specific elements thereof. It will, however, be evident that various modifications and changes may be made thereto without departing from the broader spirit and scope of the embodiments. Thus the drawings and descriptions are, accordingly, to be regarded in an illustrative rather than restrictive sense.

### Diagram 5001 Depicts an Exemplary Embodiment of a Playlist 5201.

The depicted HLS playlist 5201 describes 1800 seconds of a media asset. Each of 1800 media URIs identifies a particular one-second segment of the asset. A naming convention of “a.ts/#” is employed for the media URIs, where “#” is an index that spans the range of 0 to 1799, thus identifying each of 1800 one-second segments within the asset. In some embodiments, the media asset can comprise a single asset file, comprising 1800 seconds of data. In this case, each of the media URIs can be understood to specify a corresponding offset into the single asset file. Each media URI can be a file name comprising the index, thus the embodiment can comprise a large number, 1800, of file names. However, the large number of file names does not necessarily require a corresponding large number of files, as the file names can be interpreted as offsets into a single media asset file. The file name, as depicted, comprises a directory name “a.ts” and file names “#” where “#” is the incrementing index. Notably, the finest resolution of the file name, and the index, can be identical.

Line 5101 indicates that this is an extended m3u file.

Line 5102 specifies a maximum media segment duration of 1 second.

Line 5103 specifies the sequence number of the first segment as 0.

Line 5104 specifies a decryption method for specified media segments.

Line 5105 specifies the duration of the following media segment to be 1 second.

Line 5106 identifies “a.ts/0” media URI.

Line 5107 specifies the duration of the following media segment to be 1 second.

Line 5108 identifies “a.ts/1” media URI.

Line 5109 specifies the duration of the following media segment to be 1 second.

Line 5110 identifies “a.ts/2” media URI.

Line 5111 repeats the functions of Lines 5109, 5110 another 1795 times, incrementing the file URL a.ts/# each time. That is, “#” successively takes on the values 3, 4, 5, . . . , 1797.

Line 5112 specifies the duration of the following media segment to be 1 second.

Line 5113 identifies “a.ts/1798” media URI.

Line 5114 specifies the duration of the following media segment to be 1 second.

Line 5115 identifies “a.ts/1799” media URI.

In this example, a file URI holds the offset of the media segment in seconds that can be interpreted by a program within a server. An HLS #EXT-X-BYTERANGE tag is not used to specify the size of one-second media segments in bytes.

In some embodiments, a Media Streamer 1301 3301 can comprise such a program, such as a CGI server program. The server can maintain a metadata index file that maps time in seconds to the byte range offsets into the media file corresponding to the time offset. For example, segment a.ts/0 can correspond to the segment of a TSB media file that starts at time t=0 and has byte offset 0. For a first segment 154543 bytes long, the next segment signaled by a.ts/1 and starting at t=1 seconds can begin at a byte offset of 154543 bytes into the TSB media file.

The playlist file 5201 depicted has a size of 40446 bytes.

In additional example embodiments, this example can be modified for two-second media segment sizes. In some such embodiments, the overall TSB initial playlist file size can be reduced to 19846 bytes.

The byte count of 19846 bytes for an embodiment corresponding to a modified playlist 5201 can be described. The ASCII representation of the text #EXTM3U through the first #EXTINF can comprise 156 bytes. For chunk durations of 2 seconds, 900 repeats of 5105-5106 may be required. The #EXTINF:2, lines can comprise 12 bytes each, while the a.ts/0 to a.ts/9 lines can comprise 8 bytes, the a.ts/10-99 lines can comprise 9 bytes, and the a.ts/100-899 lines can comprise 10 bytes, thereby forming a total 156+900×12+10×8+90×9+800×10=19846 bytes. Notably, each line can have a <CR><LF> which may contribute an extra 2-bytes per line in the calculations.

Embodiments corresponding to diagram 5001 have been described with reference to specific elements thereof. It will, however, be evident that various modifications and changes may be made thereto without departing from the broader spirit and scope of the embodiments. Thus the drawings and descriptions are, accordingly, to be regarded in an illustrative rather than restrictive sense.

### Diagram 6001 Depicts an Exemplary Embodiment of a Playlist 6201.

The depicted HLS playlist 6201 describes 1800 seconds of a media asset. Each of 1800 media URIs identifies a particular one-second segment of the asset. A naming convention of “a#.ts” is employed for the media URIs, where “#” is an index that spans the range of 0 to 1799, thus identifying each of 1800 one-second segments within the asset. In some embodiments, the media asset can comprise a single asset file, comprising 1800 seconds of data. In this case, each of the media URIs can be understood to specify a corresponding offset into the single asset file. Each media URI can be a file name comprising the index, thus the embodiment can comprise a large number, 1800, of file names. However, the large number of file names does not necessarily require a corresponding large number of files, as the file names can be interpreted as offsets into a single media asset file.

Line 6101 indicates that this is an extended m3u file.

Line 6102 specifies a maximum media segment duration of 1 second.

Line 6103 specifies the sequence number of the first segment as 0.

Line 6104 specifies a decryption method for specified media segments.

Line 6105 specifies the duration of the following media segment to be 1 second.

Line 6106 identifies “a0.ts” media URI.

Line 6107 specifies the duration of the following media segment to be 1 second.

Line 6108 identifies “a1.ts” media URI.

Line 6109 specifies the duration of the following media segment to be 1 second.

Line 6110 identifies “a2.ts” media URI.

Line 6111 repeats the functions of Lines 6109, 6110 another 1795 times, incrementing the file URL a#.ts each time. That is, “#” successively takes on the values 3, 4, 5, . . . , 1797.

Line 6112 specifies the duration of the following media segment to be 1 second.

Line 6113 identifies “a1798.ts” media URI.

Line 6114 specifies the duration of the following media segment to be 1 second.

Line 6115 identifies “a.1799.ts” media URI.

In this example, a filename can specify the offset of the media segment in seconds. An HLS #EXT-X-BYTERANGE tag is not used to specify the size of a one-second media segment in bytes.

In an embodiment, a server can maintain a metadata index file that maps time in seconds to the byte range offsets into the media file corresponding to the time offset. For example, segment a0.ts can correspond to a segment of a TSB media file that starts at time t=0 and byte offset 0. For a first segment of length 154543 bytes, the next segment can be signaled by a1.ts starting at t=1 seconds, and beginning at a byte offset of 154543 bytes into the TSB media file.

In other embodiments, a server can store the segments as individual media files. In such embodiments of this example, there can be 1800 individual files per TSB.

A design choice between embodiments can take into consideration a comparison of the burdens of managing a large number of files against the burdens of creating and maintaining a metadata index file for a single large media file. The playlist file depicted has a size of 38646 bytes.

In an example embodiment comprising a TSB that is 1800 seconds into a client's playback interval, the #EXT-X-MEDIA-SEQUENCE value will be 1800, the first file name in the playlist will be a1800.ts, and the last file name in the playlist will be a3599.ts. These added characters can increase the TSB playlist file to a size of 39759 bytes.

Embodiments corresponding to diagram 6001 have been described with reference to specific elements thereof. It will, however, be evident that various modifications and changes may be made thereto without departing from the broader spirit and scope of the embodiments. Thus the drawings and descriptions are, accordingly, to be regarded in an illustrative rather than restrictive sense.

### Diagram 7001 Depicts an Exemplary Embodiment of a Manifest 7201.

This manifest 7201 corresponds to an example embodiment comprising a 300 second playlist, and the use of BYTERANGE statements to specify a number of bytes for each 2-second segment.

Line 7101 indicates that this is an extended m3u file.

Line 7102 indicates the compatibility version of HLS protocol corresponding to this playlist as 4.

Line 7103 specifies the sequence number of the first segment as 1.

Line 7104 specifies a maximum media segment duration of 1 second.

Line 7105 indicates that the client must not cache downloaded media segments for later replay.

Line 7106 specifies a decryption method for specified media segments.

Line 7107 specifies the duration of the following media segment to be 2 seconds.

Line 7108 specifies that a media segment is a sub-range of the resource identified by the next media URI that follows it in the playlist. The sub-range length is specified as 177296 bytes, with an offset of 0 bytes.

Line 7109 identifies “11_{—}63.ts” media URI.

Line 7110 specifies the duration of the following media segment to be 2 seconds.

Line 7111 specifies that a media segment is a sub-range of the resource identified by the next media URI that follows it in the playlist. The sub-range length is specified as 174480 bytes. The sub-range begins at the next byte following the sub-range of the previous media segment.

Line 7112 identifies “11_{—}63.ts” media URI.

Line 7113 indicates that the manifest 7201 can comprise additional lines of code.

In some embodiments, such additional lines can comprise three-line groups comprising EXTINF, EXT-X-BYTERANGE, and media URI. Such groups can specify subsequent consecutive media segments, similarly to such specifications on lines 7108-7110.

In various system embodiments, stored media content can be located in a media server device such as Media Streamer 1301 3301, and/or located in a client device such as Client 1101 2101 3101. By way of non-limiting examples, a media server device, such as Media Streamer 1301 3301, can comprise a Televation or VMS streaming device. A client device can comprise local storage. By way of non-limiting examples, such client devices can comprise iPad and/or Android tablets. By way of non-limiting examples, local storage on such client devices can comprise a Secure Digital memory device, such as a SDCard, and/or any other known and/or convenient memory on a client device.

Diagram 7001 and description correspond to the first case, that of stored media content located at a media server device. Diagram 8001 and description correspond to the second case, that of stored media content located at a client device.

In an embodiment corresponding to diagram 7001, Media Streamer 1301 3301 can comprise stored media content. A client 1101 2101 3101 comprising a player can be given a URL for a stored VOD media asset manifest 7201. The term VOD, as used herein, can correspond to video on-demand. Such a URL can reference a device server Media Streamer 3301. By way of non-limiting example, the player can be given a manifest URL:
http://streamer-205.local/Dvr/Record/63/11_{—}63.m3u8

Elements of such a manifest URL can comprise:
“63” indicating a program ID;
“11” indicating a channel number of an original recording; and,
“/Dvr/Record/63” indicating an HTTP server content directory.

A media file .ts corresponding to this example can be an MPEG2 media file, and can be located in a server content directory, such as depicted example “/Dvr/Record/63”. A manifest 7201 can employ relative URIs, relative to such a server content directory.

Example manifest 7201 comprises byterange tagged relative media URIs, and a keytag 7106 referencing an iprm server.

### Diagram 8001 Depicts an Exemplary Embodiment of a Playlist 8201.

This manifest 8201 corresponds to an example embodiment comprising a 300 second playlist, and the use of BYTERANGE statements to specify a number of bytes for each 2-second segment.

Line 8101 indicates that this is an extended m3u file.

Line 8102 specifies a maximum media segment duration of 2 seconds.

Line 8103 specifies the sequence number of the first segment as 0.

Line 8104 specifies a decryption method for specified media segments.

Line 8105 specifies the duration of the following media segment to be 2 seconds.

Line 8106 specifies that a media segment is a sub-range of the resource identified by the next media URI that follows it in the playlist. The sub-range length is specified as 255000 bytes, with an offset of 0 bytes.

Line 8107 identifies “movie.ts” media URI.

Line 8108 specifies the duration of the following media segment to be 2 seconds.

Line 8109 specifies that a media segment is a sub-range of the resource identified by the next media URI that follows it in the playlist. The sub-range length is specified as 255000 bytes. The sub-range begins at the next byte following the sub-range of the previous media segment.

Line 8110 identifies “movie.ts” media URI.

Lines 8111, 8112, 8113 respectively repeat the functions of Lines 8108, 8109, 8110.

Line 8114 repeats the functions of Lines 8111,8112, 8113 another 145 times.

Lines 8115, 8116, 8117 respectively repeat the functions of Lines 8111,8112, 8113.

Lines 8118, 8119, 8120 respectively repeat the functions of Lines 8115, 8116, 8117.

Line 8121 indicates that no more media segments will be added to the playlist file.

In an example embodiment corresponding to diagram 8201, a media file such as an HLS VOD media file, can be located in memory within a client device, Client 1131 2131 3131. Such a client device can comprise a player. Playback corresponding to the client device can be initiated by giving the player a localhost URI with port number for a playlist file 8201. By way of non-limiting example, such an URI can be http://localhost:667/11_{—}63.m3u8. The file name 11_{—}63.m3u8 can refer to playlist file 8201.

For some client embodiments comprising Android operating system and/or other Android technologies, decryption can be implemented as a plug-in. In such embodiments, a keytag specifying decryption 8104 can be implemented and/or interpreted differently than for the depicted example 8201. Example manifest 8201 comprises byterange tagged relative media URIs

A proxy server such as HLS Content HTTP Proxy Server 3115 can locate a media file within local storage 3131 of a Client 3101. By way of non-limiting example, a /11_{—}63/11_{—}63.ts file can be located in response to the client player issuing http://localhost/11_{—}63.ts byterange GETs.

The size of example playlist 8201 can be determined. An HLS #EXT-X-BYTERANGE tag can be used to specify the size of a two-second media segment, in bytes. Playlist 8201 can represent the first 150 segments of a scheduled recording file movie.ts. The playlist 8201 can be terminated by an #EXT-X-ENDLIST tag 8121. This tag can indicate to the client that the playlist 8201 will not be updated. In some embodiments, a Client 1101 2101 3101 typically downloads such a playlist 8201 file once, corresponding to one instance of a playback time.

An asset file can comprise a plurality of chunks, and notably such an asset file can be identified as a resource throughout a playlist, such as playlist 8201, by a single asset name, such as movie.ts. The example playlist file 8201 can have a size of 7222 bytes.

Embodiments corresponding to diagrams 8001 and 9001 have been described with reference to specific elements thereof. It will, however, be evident that various modifications and changes may be made thereto without departing from the broader spirit and scope of the embodiments. Thus the drawings and descriptions are, accordingly, to be regarded in an illustrative rather than restrictive sense.

### Exemplary Computer System to Implement

The execution of the sequences of instructions required to practice the embodiments may be performed by a computer system 9000 as shown in FIG. 9. In an embodiment, execution of the sequences of instructions is performed by a single computer system 9000. According to other embodiments, two or more computer systems 9000 coupled by a communication link 9015 may perform the sequence of instructions in coordination with one another. Although a description of only one computer system 9000 may be presented herein, it should be understood that any number of computer systems 9000 may be employed.

A computer system 9000 according to an embodiment will now be described with reference to FIG. 9, which is a block diagram of the functional components of a computer system 9000. As used herein, the term computer system 9000 is broadly used to describe any computing device that can store and independently run one or more programs.

The computer system 9000 may include a communication interface 9014 coupled to the bus 9006. The communication interface 9014 provides two-way communication between computer systems 9000. The communication interface 9014 of a respective computer system 9000 transmits and receives electrical, electromagnetic or optical signals, that include data streams representing various types of signal information, e.g., instructions, messages and data. A communication link 9015 links one computer system 9000 with another computer system 9000. For example, the communication link 9015 may be a LAN, an integrated services digital network (ISDN) card, a modem, or the Internet.

A computer system 9000 may transmit and receive messages, data, and instructions, including programs, i.e., application, code, through its respective communication link 9015 and communication interface 9014. Received program code may be executed by the respective processor(s) 9007 as it is received, and/or stored in the storage device 9010, or other associated non-volatile media, for later execution.

In an embodiment, the computer system 9000 operates in conjunction with a data storage system 9031, e.g., a data storage system 9031 that contains a database 9032 that is readily accessible by the computer system 9000. The computer system 9000 communicates with the data storage system 9031 through a data interface 9033.

Computer system 9000 can include a bus 9006 or other communication mechanism for communicating the instructions, messages and data, collectively, information, and one or more processors 9007 coupled with the bus 9006 for processing information. Computer system 9000 also includes a main memory 9008, such as a random access memory (RAM) or other dynamic storage device, coupled to the bus 9006 for storing dynamic data and instructions to be executed by the processor(s) 9007. The computer system 9000 may further include a read only memory (ROM) 9009 or other static storage device coupled to the bus 9006 for storing static data and instructions for the processor(s) 9007. A storage device 9010, such as a magnetic disk or optical disk, may also be provided and coupled to the bus 9006 for storing data and instructions for the processor(s) 9007.

A computer system 9000 may be coupled via the bus 9006 to a display device 9011, such as an LCD screen. An input device 9012, e.g., alphanumeric and other keys, is coupled to the bus 9006 for communicating information and command selections to the processor(s) 9007.

According to one embodiment, an individual computer system 9000 performs specific operations by their respective processor(s) 9007 executing one or more sequences of one or more instructions contained in the main memory 9008. Such instructions may be read into the main memory 9008 from another computer-usable medium, such as the ROM 9009 or the storage device 9010. Execution of the sequences of instructions contained in the main memory 9008 causes the processor(s) 9007 to perform the processes described herein. In alternative embodiments, hard-wired circuitry may be used in place of or in combination with software instructions. Thus, embodiments are not limited to any specific combination of hardware circuitry and/or software.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

1. A system for delivery and playback of bounded multimedia data files, comprising:
a client device comprising local storage and configured to:
perform playback responsive to at least one of a playlist file identifier, an asset file identifier, a security dialog, and local storage;
provide a playlist file request corresponding to a playlist file and the playlist file identifier, the playlist file comprising one or more instances of media URIs corresponding to an asset file;
provide an asset file request corresponding to an asset file and the asset file identifier, the asset file comprising a bounded media file;
instantiate the playlist file and the asset file in local storage; and,
selectively communicate with a media gateway;
wherein the media URIs are referenced to the playlist file identifier.

2. The system of claim 1:
wherein selectively communicating with the media gateway comprises:
receiving the playlist file; and,
receiving the asset file.

3. The system of claim 2:
wherein each instance of a media URI comprises a file name, and,
the file name specifies a corresponding offset within the asset file.

4. The system of claim 3:
wherein the file name comprises an index, and, the corresponding offset is responsive to the index;

5. The system of claim 4:
wherein the file name and the index are identical.

6. The system of claim 2:
wherein the playlist file comprises a specification for a transfer of the entire asset file.

7. The system of claim 2:
wherein the client device is further configured to:
concurrently instantiate the asset file in local storage and perform playback.

8. The system of claim 2:
wherein the one or more instances of media URIs identify the asset file as a resource, by a single asset name.

9. The system of claim 8:
wherein the playlist comprises one or more instances of a specification of a media segment according to an HLS protocol;
wherein the specification of the media segment specifies at least one selected from the group consisting of:
a byte offset, and, a length of the media segment; and,
the length of the media segment.

10. A method for delivery and playback of bounded multimedia data files, comprising the steps of:
providing a client device comprising local storage;
performing playback responsive to at least one of a playlist file identifier, an asset file identifier, a security dialog, and local storage;
providing a playlist file request corresponding to a playlist file and the playlist file identifier, the playlist file comprising one or more instances of media URIs corresponding to an asset file;
providing an asset file request corresponding to an asset file and the asset file identifier, the asset file comprising a bounded media file;
instantiating the playlist file and the asset file in local storage; and,
selectively communicating with a media gateway;
wherein the media URIs are referenced to the playlist file identifier.

11. The method of claim 10:
wherein selectively communicating with the media gateway comprises:
receiving the playlist file; and,
receiving the asset file.

12. The method of claim 11:
wherein each instance of a media URI comprises a file name, and,
the file name specifies a corresponding offset within the asset file.

13. The method of claim 12:
wherein the file name comprises an index, and, the corresponding offset is responsive to the index;

14. The method of claim 13:
wherein the file name and the index are identical.

15. The method of claim 11:
wherein the playlist file comprises a specification for a transfer of the entire asset file.

16. The method of claim 11:
wherein instantiating the playlist file and the asset file in local storage, and, performing playback, are concurrent.

17. The method of claim 11:
wherein the one or more instances of media URIs identify the asset file as a resource, by a single asset name.

18. The method of claim 17:
wherein the playlist comprises one or more instances of a specification of a media segment according to an HLS protocol;
wherein the specification of the media segment specifies at least one selected from the group consisting of:
a byte offset, and, a length of the media segment; and,
the length of the media segment.

19. A system for delivery and playback of bounded multimedia data files, comprising:
a media gateway configured to:
perform a security dialog;
receive a content list request;
provide a content list responsive to the contest list request, the content list comprising a playlist file identifier and an asset file identifier;
provide an asset file corresponding to the asset file identifier, the asset file comprising a bounded media file; and,
provide a playlist file corresponding to the playlist file identifier, the playlist comprising one or more instances of media URIs corresponding to the asset file; and,
selectively communicate with a client device;
wherein the media URIs are referenced to the playlist file identifier.

20. The system of claim 19:
wherein selectively communicating with the client device comprises:
providing the playlist file; and,
providing the asset file.

21. The system of claim 20:
wherein each instance of a media URI comprises a file name, and, the file name specifies a corresponding offset within the asset file.

22. The system of claim 21:
wherein the file name comprises an index, and, the corresponding offset is responsive to the index;

23. The system of claim 22:
wherein the file name and the index are identical.

24. The system of claim 20:
wherein the playlist file comprises a specification for a transfer of the entire asset file.

25. The system of claim 20:
wherein the client device is further configured to:
concurrently instantiate the asset file in local storage and perform playback.

26. The system of claim 20:
wherein the one or more instances of media URIs identify the asset file as a resource, by a single asset name.

27. The system of claim 26:
wherein the playlist comprises one or more instances of a specification of a media segment according to an HLS protocol;
wherein the specification of the media segment specifies at least one selected from the group consisting of:
a byte offset, and, a length of the media segment; and,
the length of the media segment.

28. A method for delivery and playback of bounded multimedia data files, comprising the steps of:
providing a media gateway comprising a content list;
performing a security dialog;
receiving a content list request;
providing the content list responsive to the contest list request, the content list comprising a playlist file identifier and an asset file identifier;
providing an asset file corresponding to the asset file identifier, the asset file comprising a bounded media file; and,
providing a playlist file corresponding to the playlist file identifier, the playlist comprising one or more instances of media URIs corresponding to the asset file;
selectively communicating with a client device; and,
wherein the media URIs are referenced to the playlist file identifier.

29. The method of claim 10:
wherein selectively communicating with the client device comprises:
providing the playlist file; and,
providing the asset file.

30. The method of claim 29:
wherein each instance of a media URI comprises a file name, and,
the file name specifies a corresponding offset within the asset file.

31. The method of claim 30:
wherein the file name comprises an index, and, the corresponding offset is responsive to the index;

32. The method of claim 31:
wherein the file name and the index are identical.

33. The method of claim 29:
wherein the playlist file comprises a specification for a transfer of the entire asset file.

34. The method of claim 29:
wherein instantiating the playlist file and the asset file in local storage, and, performing playback, are concurrent.

35. The method of claim 29:
wherein the one or more instances of media URIs identify the asset file as a resource, by a single asset name.

36. The method of claim 35:
wherein the playlist comprises one or more instances of a specification of a media segment according to an HLS protocol;
wherein the specification of the media segment specifies at least one selected from the group consisting of:
a byte offset, and, a length of the media segment; and,
the length of the media segment.
